(19) United States
(12) Patent Application Publication
(10) Pub. No.: US 2022/0248660 A1
(43) Pub. Date: Aug. 11, 2022

(54) ULTRASONIC ENERGY GATHERING DEVICE AND ULTRASONIC REPELLER USING ULTRASONIC ENERGY GATHERING DEVICE

(71) Applicant: Shenzhen DogCare Innovation & Technology Co., Ltd., Shenzhen (CN)

(72) Inventors: Qingyong CHEN, Shenzhen (CN); Zhifeng LIU, Shenzhen (CN); Xiaona LIU, Shenzhen (CN); Xin HUANG, Shenzhen (CN)

(73) Assignee: Shenzhen DogCare Innovation & Technology Co., Ltd., Shenzhen (CN)

(21) Appl. No.: 17/375,020

(22) Filed: Jul. 14, 2021

(30) Foreign Application Priority Data
Feb. 9, 2021 (CN) 202120366952.0

(51) Int. Cl. A01M 29/18

(52) U.S. Cl. CPC A01M 29/18

(57) ABSTRACT

An ultrasonic energy gathering device and an ultrasonic repeller using the ultrasonic energy gathering device are provided. The ultrasonic energy gathering device includes an energy gathering part. The energy gathering part has a trapezoidal cross section. The energy gathering part is provided with a gathering port and a diffusing port. The gathering port is smaller than the diffusing port. The ultrasonic energy gathering device further includes an ultrasonic fixing part. The ultrasonic fixing part fixes the ultrasonic energy gathering device with an ultrasonic transmitter of an ultrasonic repeller, so that an ultrasonic wave transmitted from the ultrasonic transmitter enters the gathering port to be gathered and strengthened, and the coverage of the ultrasonic wave gradually expands along the direction away from the diffusing port under the action of the ultrasonic energy gathering device.

### CROSS REFERENCE TO THE RELATED APPLICATIONS

This application is based upon and claims priority to Chinese Patent Application No. 202120366952.0, filed on Feb. 9, 2021, the entire contents of which are incorporated herein by reference.

### TECHNICAL FIELD

The present invention relates to the technical field of ultrasonic repellers, and more particularly, to an ultrasonic energy gathering device and an ultrasonic repeller using the ultrasonic energy gathering device.

### BACKGROUND

Sounds that human beings can hear are in the frequency range of 20-20000 Hz. Sounds with a frequency lower than 20 Hz are infrasonic wave, and sounds with a frequency higher than 20000 Hz are ultrasonic wave. Because of the structure of the human ear, neither infrasonic wave nor ultrasonic wave can be heard by the human ear. Animals, however, can hear sounds in a wider frequency range. For example, dogs can hear sounds in the range of 65-50000 Hz, and mice can hear sounds in the range of 200-76000 Hz.

Ultrasonic repellers ward off animals by generating a high-decibel ultrasonic wave that cannot be heard by the human ear. The prior ultrasonic repellers generally produce an ultrasonic wave with a frequency of 25 KHz.

In order to generate the high-decibel ultrasonic wave, the ultrasonic repeller is required to be driven in a high power. However, the rated loading power of the ultrasonic transmitter is limited. In addition, the ultrasonic wave attenuates quickly in a process of propagating in air due to its high frequency, causing that the effective distance of the ultrasonic repeller is short and the repelling effect is not ideal.

### SUMMARY

### (1) Technical Problem to be Solved

In order to overcome the above shortcomings of the prior art, the present invention provides an ultrasonic energy gathering device and an ultrasonic repeller using the ultrasonic energy gathering device. The present invention solves the technical problem of poor repelling effect due to the low intensity of the ultrasonic wave transmitted by the ultrasonic transmitting device of the ultrasonic repeller in the prior art.

### (2) Technical Solution

To achieve the above objective, the present invention adopts the following technical solutions.

A first aspect of the present invention provides an ultrasonic energy gathering device. The ultrasonic energy gathering device includes an energy gathering part. The energy gathering part has a trapezoidal cross section. The energy gathering part is provided with a gathering port and a diffusing port. The gathering port is smaller than the diffusing port.

The ultrasonic energy gathering device further includes an ultrasonic fixing part. The ultrasonic fixing part fixes the ultrasonic energy gathering device with an ultrasonic transmitter of an ultrasonic repeller, so that an ultrasonic wave transmitted from the ultrasonic transmitter enters the gathering port to be gathered and strengthened, and the coverage of the ultrasonic wave gradually expands along the diffusing port under the action of the ultrasonic energy gathering device.

Optionally, an ultrasonic gain effect of the ultrasonic energy gathering device is in a positive correspondence relationship with a length of the energy gathering part, and the ultrasonic gain effect increases as an energy gathering angle α approaches 30°, where the energy gathering angle α is an angle between an inner wall of the energy gathering part and an axial direction of the energy gathering part.

Optionally, an energy gathering angle α is 20-35°, or the energy gathering angle α is 30°, wherein the energy gathering angle α is an angle between an inner wall of the energy gathering part and an axial direction of the energy gathering part.

Optionally, an inner wall of the energy gathering part is a smooth plane, or the inner wall of the energy gathering part is provided with a smooth stepped surface.

A second aspect of the present invention provides an ultrasonic repeller, including an ultrasonic transmitting device and the ultrasonic energy gathering device of the first aspect of the present invention.

The ultrasonic transmitting device includes a transmitting device body, an ultrasonic transmitter and a transmitter shell. The transmitting device body is provided at the rear end of the ultrasonic transmitter. The ultrasonic transmitter is fixed in the transmitter shell.

The ultrasonic transmitter and the fixing part of the ultrasonic energy gathering device are fixed on the transmitter shell, and a transmitting port of the ultrasonic transmitter is located at the gathering port of the ultrasonic energy gathering device.

Optionally, the ultrasonic repeller further includes a power source and a body shell. The power source is located at the tail part of the body shell and is electrically connected to the ultrasonic transmitting device. The head part of the body shell is fixed with the transmitter shell.

Optionally, at least one button is provided on the transmitting device body, and the body shell is provided with an opening corresponding to the button.

Optionally, the body shell is further provided with a micro universal serial bus (USB) interface, and the micro USB interface is electrically connected to the power source.

### (3) Advantages

The present invention has the following advantages. The present invention provides an ultrasonic energy gathering device and an ultrasonic repeller using the ultrasonic energy gathering device. The ultrasonic transmitter of the ultrasonic transmitting device is provided at the ultrasonic gathering port of the energy gathering device. The ultrasonic wave transmitted from the ultrasonic transmitter enters the energy gathering part of the energy gathering device from the gathering port, is gathered and strengthened under the action of the energy gathering part, and then is diffused out of the diffusing port. In this way, the ultrasonic wave is concentrated in front of the diffusing port, so as to increase the intensity of the ultrasonic wave and extend the effective distance of the ultrasonic repeller. In addition, the coverage of the ultrasonic wave gradually expands along the direction away from the ultrasonic diffusing port after the ultrasonic wave is diffused out of the diffusing port, thereby avoiding the problem that the excessively small effective coverage causes the difficulty for actual operation due to excessive concentration of the ultrasonic wave.

### BRIEF DESCRIPTION OF THE DRAWINGS

FIG. 1 is a perspective view of an energy gathering device according to Embodiment 1 of the present invention.

FIG. 2 is a cross-sectional view of an energy gathering part with a smooth inner wall in an ultrasonic energy gathering device.

FIG. 3 is a cross-sectional view of an energy gathering part with a smooth stepped surface on an inner wall in an ultrasonic energy gathering device.

FIG. 4 is a schematic diagram of a test of an ultrasonic transmitting device that does not use an ultrasonic energy gathering device.

FIG. 5 is a schematic diagram of a test of an ultrasonic transmitting device that uses an ultrasonic energy gathering device.

FIG. 6 is a perspective view of an ultrasonic repeller according to the present invention.

FIG. 7 is an exploded view of the ultrasonic repeller in FIG. 6.

In the figures:
100. body shell; 110. upper cover; 120. lower cover; 200. power source; 300. ultrasonic transmitting device; 310. transmitting device body; 320. ultrasonic transmitter; 321. ultrasonic transmitting port; 331. upper shell; 332. lower shell; 333. indicator light; 400. ultrasonic energy gathering device; 410. gathering port; 420. diffusing port; 430. fixing part; and 500. decorative ring.

### DETAILED DESCRIPTION OF THE EMBODIMENTS

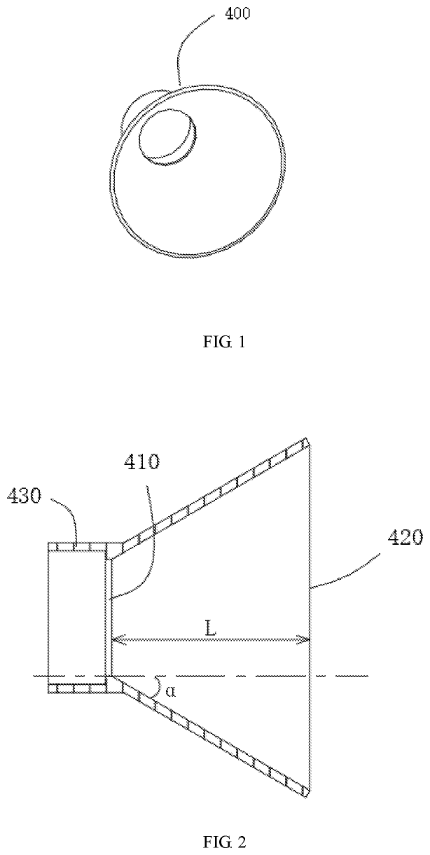

In order to better explain the present invention and facilitate understanding, the present invention is described in detail below with reference to the drawings and embodiments. Specifically, the terms such as “up”, “down” and others mentioned herein are based on the orientations shown in FIG. 1.

The embodiments of the present invention provide an ultrasonic energy gathering device and an ultrasonic repeller using the ultrasonic energy gathering device. The ultrasonic repeller includes an ultrasonic transmitting device and the ultrasonic energy gathering device. The ultrasonic energy gathering device is provided with a horn-shaped energy gathering part. Both ends of the energy gathering part are provided with a gathering port and a diffusing port, respectively. The gathering port is smaller than the diffusing port. The energy gathering part has a trapezoidal cross section. The ultrasonic transmitting device is provided with an ultrasonic transmitter. A transmitting port of the ultrasonic transmitter is placed at the gathering port of the energy gathering part. After an ultrasonic wave enters the gathering port, the ultrasonic wave is gathered and strengthened, and the coverage of the ultrasonic wave gradually expands along the diffusing port under the action of the ultrasonic energy gathering device.

In the present invention, the ultrasonic energy gathering device is added in an ultrasonic transmission direction. The inner wall of the energy gathering part of the ultrasonic energy gathering device employs a smooth plane or a smooth stepped surface, which can gather and strengthen the ultrasonic wave and enable the ultrasonic wave to diffuse along the diffusing port of the energy gathering part. The ultrasonic energy gathering device can be used in various ultrasonic repellers, such as ultrasonic dog repeller, ultrasonic wolf repeller, ultrasonic mouse repeller and other similar devices.

In order to facilitate a better understanding of the above technical solutions, the exemplary embodiments of the present invention are described in detail below with reference to the drawings. Although the drawings show the exemplary embodiments of the present invention, it should be understood that the present invention may be implemented in various forms and should not be limited to the embodiments set forth herein. On the contrary, these embodiments are provided such that the present invention is more fully understandable, and fully conveys the scope of the present invention to those skilled in the art.

### SPECIFIC EMBODIMENTS

### Embodiment 1

Referring to FIGS. 1 to 3, according to the present embodiment, the ultrasonic energy gathering device 400 is provided with a horn-shaped energy gathering part. Both ends of the energy gathering part are provided with the gathering port 410 and the diffusing port 420, respectively. The gathering port 410 is smaller than the diffusing port 420. The energy gathering part has a trapezoidal cross section. The fixing part 430 is provided at the gathering port 410, and an accommodating cavity is provided in the fixing part 430. The fixing part 430 may be fixed on an ultrasonic transmitting device, and an ultrasonic transmitter of the ultrasonic transmitting device is accommodated in the accommodating cavity. An ultrasonic transmitting port of the ultrasonic transmitter is placed at the gathering port 410 of the energy gathering part. After an ultrasonic wave enters the gathering port 410, the ultrasonic wave is gathered and strengthened, and the coverage of the ultrasonic wave gradually expands along a direction away from the diffusing port 420 under the action of the energy gathering part.

In a practical application, the fixing part 430 may also be provided on the outer wall of the energy gathering part. The accommodating cavity may not be necessarily provided, as long as the ultrasonic transmitter is located in the gathering port. In this way, the ultrasonic wave transmitted from the ultrasonic transmitter can enter the energy gathering part as much as possible, so as to improve a gain effect of the energy gathering part.

Specifically, the ultrasonic transmitter is placed in the gathering port 410. In this way, the ultrasonic wave transmitted from the ultrasonic transmitting port 321 is reflected by the inner wall of the energy gathering part, so as to be gathered and strengthened into the diffusing port 420 to be diffused out. The diffusing coverage of the ultrasonic wave is concentrated in front of the diffusing port 420, and the coverage of the ultrasonic wave gradually expands along the direction away from the diffusing port 420. Thus, while the intensity of the ultrasonic wave is increased, it is avoided that the excessively small effective coverage causes the difficulty for actual operation due to excessive concentration of the ultrasonic wave.

Referring to FIG. 2, an angle between the inner wall of the energy gathering part and the axial direction of the energy gathering part is defined as the energy gathering angle α. and the length L of the energy gathering part is a distance between the gathering port 410 and the diffusing port 420. The gain effect of the energy gathering part is in a positive correspondence relationship with L, and increases as the energy gathering angle α approaches 30°.

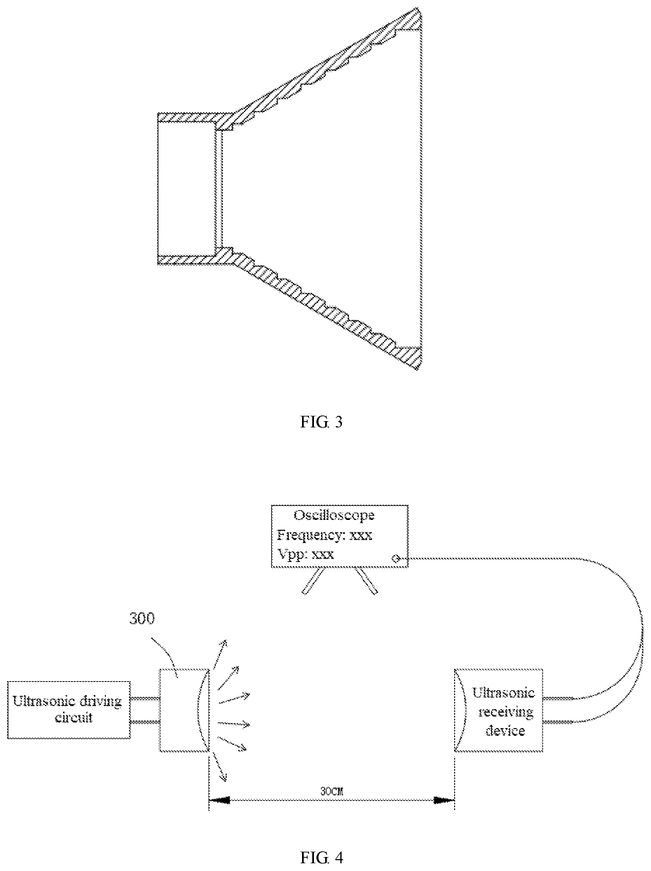

FIG. 4 is a schematic diagram of a test of an ultrasonic transmitting device that does not use an ultrasonic energy gathering device. FIG. 5 is a schematic diagram of a test of an ultrasonic transmitting device that uses an ultrasonic energy gathering device.

An identical ultrasonic driving circuit is used to test the ultrasonic transmitting device 300 that uses the ultrasonic energy gathering device 400 with different dimensional parameters (α and L) and to test the ultrasonic transmitting device 300 that does not use the ultrasonic energy gathering device 400. A distance between the ultrasonic transmitting device 300 and an ultrasonic receiving device is fixed at 30 cm. An ultrasonic transmitting sensor of the ultrasonic transmitting device 300 transmits an ultrasonic wave. An ultrasonic receiving sensor of the ultrasonic receiving device receives the ultrasonic wave and converts the received ultrasonic wave into a voltage. The voltage can be read out by a measured peak-to-peak voltage Vpp in an oscilloscope. This test can compare the received Vpp value of the ultrasonic transmitting device that does not use an energy gathering device and the received Vpp value of the ultrasonic transmitting device that uses an energy gathering device with energy gathering parts of different angles and different lengths, so that the effect of using the ultrasonic energy gathering device can be determined by comparing the Vpp values.

Table 1 shows an ultrasonic testing result of the ultrasonic transmitting device that uses an energy gathering device with different dimensional parameters (a and L) and an ultrasonic testing result of the ultrasonic transmitting device that does not use an ultrasonic energy gathering device.

TABLE 1
Energy gathering device-free
Vpp 3.0 V
Energy gathering device-based

| Vpp | Length | | | | | | | |
|---|---|---|---|---|---|---|---|---|
| Angle | 12 mm | 15 mm | 18 mm | 20 mm | 25 mm | 30 mm | 35 mm | 40 mm |
| <12 | 3.7 V | 4 V | 4.2 V | 4 V | 4.6 V | 4.7 V | 5 V | 5.4 V |
| <15 | 4 V | 4.4 V | 4.6 V | 4.6 V | 4.8 V | 5 V | 5.2 V | 5.7 V |
| <18 | 4.4 V | 4.4 V | 5.1 V | 5.3 V | 5.5 V | 5.7 V | 5.8 V | 5.8 V |
| <21 | 4.7 V | 4.7 V | 5.5 V | 5.6 V | 5.8 V | 6.1 V | 6.4 V | 6.5 V |
| <24 | 4.6 V | 5 V | 5.4 V | 5.7 V | 6 V | 6.2 V | 6.8 V | 7 V |
| <27 | 4.7 V | 5 V | 5.7 V | 5.8 V | 6.3 V | 6.5 V | 7.1 V | 7.2 V |
| <30 | 4.8 V | 5.2 V | 5.8 V | 6 V | 6.6 V | 6.7 V | 7.4 V | 7.5 V |
| <33 | 4.6 V | 5 V | 5.6 V | 5.9 V | 6.5 V | 6.6 V | 7.3 V | 7.4 V |
| <36 | 4.5 V | 4.9 V | 5.5 V | 5.7 V | 6.1 V | 6.3 V | 6.8 V | 6.9 V |
| <39 | 4.3 V | 4.5 V | 5.4 V | 5.5 V | 5.6 V | 5.8 V | 6.3 V | 6.4 V |
| <42 | 3.5 V | 3.6 V | 4.9 V | 5 V | 5 V | 5.2 V | 5.8 V | 5.8 V |
| <45 | 3.3 V | 3.5 V | 4.5 V | 4.8 V | 4.5 V | 4.8 V | 5.5 V | 5.6 V |

Table 1 shows that the Vpp value of the ultrasonic transmitting device 300 obtained after the ultrasonic energy gathering device 400 is added is greater than the Vpp value obtained when the ultrasonic energy gathering device 400 is not added. In case that the energy gathering angles are equal, the gain effect increases as the length of the energy gathering part increases. In case that the lengths of the energy gathering parts are equal, the gain effect increases as the energy gathering angle approaches 30°.

In a practical application, the energy gathering angle α may be 20-35°. When α=30°, the gain effect is optimal.

The length of the energy gathering part may be selected as needed. In order to make the ultrasonic repeller easy to carry and beautiful in appearance, the length of the energy gathering part should not be excessively large.

In a practical application, the inner wall of the energy gathering part may be a smooth plane, as shown in FIG. 2. Alternatively, the inner wall of the energy gathering part may also be a smooth stepped surface, as shown in FIG. 3, and in this case, the inner wall of the energy gathering part is provided with a step-like concave-convex pattern. Of course, wavy or other regular or irregular patterns may also be provided.

In the ultrasonic energy gathering device of the present embodiment, the ultrasonic wave enters the energy gathering part of the energy gathering device from the gathering port, is gathered and strengthened under the action of the energy gathering part, and then is diffused out of the diffusing port. In this way, the ultrasonic wave is concentrated in front of the diffusing port, so as to increase the intensity of the ultrasonic wave. In addition, the coverage of the ultrasonic wave gradually expands along the direction away from the ultrasonic diffusing port after the ultrasonic wave is diffused out of the diffusing port, thereby avoiding the problem that the excessively small effective coverage causes the difficulty for actual operation due to excessive concentration of the ultrasonic wave.

### Embodiment 2

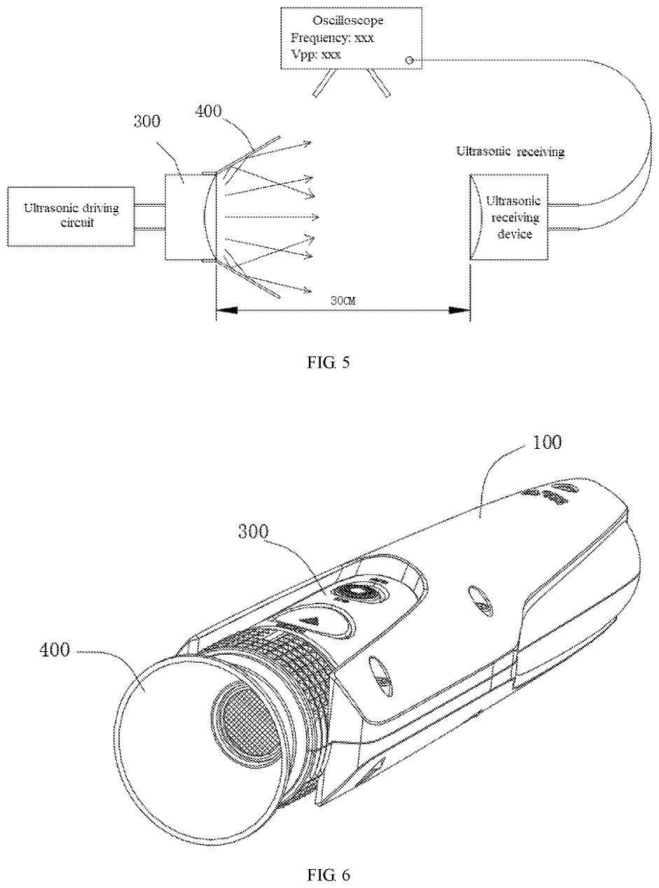

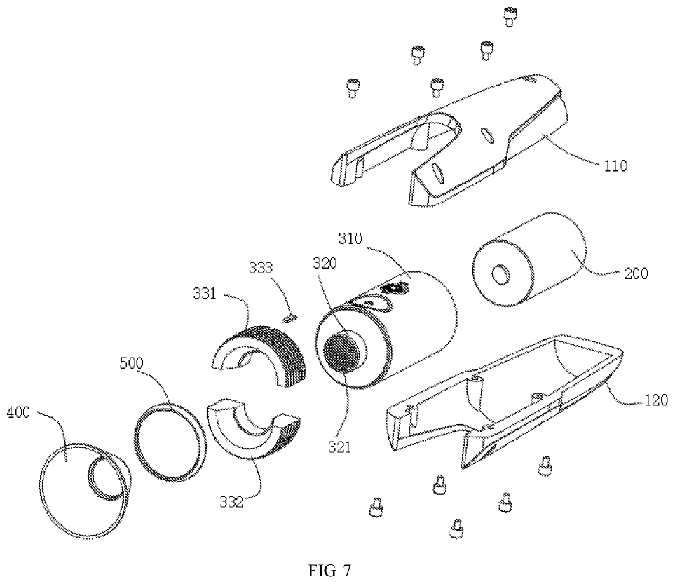

Referring to FIGS. 6 and 7, according to the present embodiment, an ultrasonic repeller includes the body shell 100, the power source 200, the ultrasonic transmitting device 300 and the ultrasonic energy gathering device 400.

The ultrasonic transmitting device 300 includes the transmitting device body 310, the ultrasonic transmitter 320 and a transmitter shell.

The transmitting device body 310 adopts a cylindrical structure, and a plurality of buttons are arranged on the side of the transmitting device body to control a working state of the ultrasonic transmitting device. The plurality of buttons at least include a switch button and a deterrent button. The switch button is configured to connect or disconnect the ultrasonic transmitting device 300 and the power source 200. The deterrent button is configured to control the ultrasonic transmitter 320 to transmit an ultrasonic wave.

In a practical application, other button may also be provided according to an actual function of the ultrasonic transmitting device 300, such as a dog training button.

The ultrasonic transmitter 320 is provided at a front end of the transmitting device body 310, and the ultrasonic transmitting port 321 is provided at an end the ultrasonic transmitter 320.

The transmitter shell is fixed on the ultrasonic transmitter 320. In order to facilitate the mounting and fixing of the ultrasonic transmitter 320 and the ultrasonic energy gathering device 400, the transmitter shell includes the upper shell 331 and the lower shell 332. The upper shell 331 and the lower shell 332 are assembled together to form a cylinder with openings at both ends. The ultrasonic transmitter 320 is fixed at the rear end of the interior of the cylinder. The indicator light 333 is further provided on the upper shell 331. The indicator light 333 is electrically connected to the transmitting device body 310, and is configured to indicate the working state of the ultrasonic transmitting device 300.

The ultrasonic energy gathering device 400 may be the ultrasonic energy gathering device in Embodiment 1, which is provided with a horn-shaped energy gathering part. Both ends of the energy gathering part are provided with the gathering port 410 and the diffusing port 420, respectively. The gathering port 410 is smaller than the diffusing port 420. The energy gathering part has a trapezoidal cross section. The fixing part 430 is provided at the gathering port 410, and an accommodating cavity is provided in the fixing part 430. The fixing part 430 may be fixed on the ultrasonic transmitting device 300, and the ultrasonic transmitter 320 of the ultrasonic transmitting device 300 is accommodated in the accommodating cavity. The ultrasonic transmitting port 321 of the ultrasonic transmitter 320 is placed at the gathering port 410 of the energy gathering part. After an ultrasonic wave enters the gathering port 410, the ultrasonic wave is gathered and strengthened, and the coverage of the ultrasonic wave gradually expands along the direction away from the diffusing port 420 under the action of the ultrasonic energy gathering device 400.

In this embodiment, the upper shell 331 and the lower shell 332 of the transmitter shell may be provided with a clamping groove. A protruding clamping member or circular ring may be provided on the ultrasonic transmitter 320. When the upper shell 331 and the lower shell 332 are matched together, the ultrasonic transmitter 320 is fixed in the transmitter shell in a clamping manner. The identical structure may also be adopted to fix the ultrasonic energy gathering device 400 in the transmitter shell.

In a practical application, the transmitter shell, the ultrasonic transmitter 320 and the ultrasonic energy gathering device 400 may also be fixed together by screw fitting, or by screws or rivets or the like. In this case, the transmitter shell may also be integrally formed without being divided into two separate shells, namely the upper shell 331 and the lower shell 332.

Referring to FIG. 7, in this embodiment, in order to make the appearance of the ultrasonic drive more beautiful, the decorative ring 500 is further provided. The decorative ring 500 is sleeved on the energy gathering part of the ultrasonic energy gathering device 400 and is in contact with the transmitter shell.

The body shell 100 includes the upper cover 110 and the lower cover 120. The upper cover 110 and the lower cover 120 are assembled together to form a cylinder with an opening at one end. The power source 200 is fixed at the rear end of the interior of the cylinder, and the power source 200 is electrically connected to the transmitting device body 310 of the ultrasonic transmitting device 300. The upper cover 110 and the lower cover 120 are fixed on the transmitter shell, and the transmitting device body 310 is provided at the front end of the interior of the cylinder. The upper cover 110 is provided with an opening corresponding to a button on the transmitting device body 310, so as to expose the button for convenient operation. The tail part of the body shell 100 is further provided with a micro universal serial bus (USB) interface, and the micro USB interface is electrically connected to the power source 200. In a practical application, the micro USB interface may be provided at the tail part of the upper cover 110 or the lower cover 120.

In this embodiment, outer side walls of the upper shell 331 and the lower shell 332 of the transmitter shell are respectively provided with clamping grooves. Inner walls of the upper cover 110 and the lower cover 120 of the body shell 100 are respectively provided with clamping members that are correspondingly matched with the clamping grooves. When the upper cover 110 and the lower cover 120 are matched together, the transmitter shell is fixed in the body shell 100 in a clamping manner.

In a practical application, the transmitter shell and the body shell 100 may also be fixed together by screw fitting, or by screws or rivets or the like. In this case, the body shell 100 may also be integrally formed without being divided into two separate covers, namely the upper cover 110 and the lower cover 120.

In a practical application, the ultrasonic repeller not only includes an ultrasonic dog repeller, and but also may include a repeller for repelling other creatures, such as an ultrasonic wolf repeller, an ultrasonic mouse repeller or other similar device.

The ultrasonic repeller in the present embodiment is provided with an ultrasonic energy gathering device, and the ultrasonic transmitting port of the ultrasonic transmitting device is provided at the ultrasonic gathering port of the energy gathering device. The ultrasonic wave transmitted from the ultrasonic transmitting port enters the energy gathering part of the energy gathering device from the gathering port, is reflected by the inner wall of the energy gathering part, and then is diffused out of the ultrasonic diffusing port. In this way, the ultrasonic wave is concentrated in front of the ultrasonic diffusing port, so as to increase the intensity of the ultrasonic wave. In addition, the coverage of the ultrasonic wave gradually expands along the direction away from the ultrasonic diffusing port after the ultrasonic wave is diffused out of the ultrasonic diffusing port, thereby avoiding the problem that the excessively small effective coverage causes the difficulty for actual operation due to excessive concentration of the ultrasonic wave.

It should be understood that in the description of the present invention, terms such as “first” and “second” are used merely for a descriptive purpose and should not be construed as indicating or implying relative importance, or implicitly indicating the number of indicated technical features. Thus, features defined with “first” and “second” may explicitly or implicitly include one or more of the features. In the description of the present invention, “a plurality of” means two or more, unless otherwise specifically defined.

In the present invention, unless otherwise clearly specified, the terms “installation”, “interconnection”, “connection” and “fixation” are intended to be understood in a broad sense. For example, the “connection” may be a fixed connection, a detachable connection or an integral connection; it may be a mechanical connection or an electrical connection; it may be a direct connection or an indirect connection though an intermediate medium; and it may be a communication between the interiors of two elements or an interaction between two elements. Those skilled in the art may understand specific meanings of the foregoing terms in the present invention based on a specific situation.

In the present invention, unless otherwise explicitly stipulated, “a first feature is above or below a second feature” may indicate that “the first feature is in direct contact with the second feature” or “the first feature is in indirect contact with the second feature through an intermediate medium”. In addition, “a first feature is over, above and on a second feature” may indicate that “the first feature is directly above and obliquely above the second feature”, or simply indicate that “the first feature is higher than the second feature”. “A first feature is under, below or beneath a second feature” may indicate that “the first feature is directly under or obliquely under the second feature” or simply indicate that “the first feature is lower than the second feature”.

In the description of this specification, the description with reference to the terms such as “an/one embodiment”, “some embodiments”, “embodiments”, “an example”, “a specific example” and “some examples” indicates that the specific features, structures, materials or characteristics described with reference to the embodiment or example are included in at least one embodiment or example of the present invention. In this specification, the illustrative expressions of the above terms do not necessarily refer to an identical embodiment or example. Moreover, the specific features, structures, materials or characteristics described may be combined in a suitable manner in any one or more embodiments or examples. In addition, those skilled in the art may combine different embodiments or examples as well as features of the different embodiments or examples described in this specification without mutual contradiction.

Although the embodiments of the present invention have been described above, it should be understood that the above embodiments are exemplary, and cannot be considered as limiting to the present invention. Those skilled in the art may make various changes, modifications, replacements and variations on the above embodiments within the scope of the present invention.

What is claimed is:

1. An ultrasonic energy gathering device, comprising an energy gathering part and an ultrasonic fixing part; wherein
the energy gathering part has a trapezoidal cross section;
the energy gathering part is provided with a gathering port and a diffusing port;
the gathering port is smaller than the diffusing port;
the ultrasonic fixing part is configured to fix the ultrasonic energy gathering device with an ultrasonic transmitter of an ultrasonic repeller;
an ultrasonic wave transmitted from the ultrasonic transmitter enters the gathering port to be gathered and strengthened; and
a coverage of the ultrasonic wave gradually expands along a direction away from the diffusing port under an action of the energy gathering part.

2. The ultrasonic energy gathering device of claim 1, wherein
an ultrasonic gain effect of the ultrasonic energy gathering device is in a positive correspondence relationship with a length of the energy gathering part; and
the ultrasonic gain effect increases as an energy gathering angle α approaches 30°, wherein the energy gathering angle α is an angle between an inner wall of the energy gathering part and an axial direction of the energy gathering part.

3. The ultrasonic energy gathering device of claim 1, wherein
an energy gathering angle α is 20-35°, or the energy gathering angle α is 30°, wherein the energy gathering angle α is an angle between an inner wall of the energy gathering part and an axial direction of the energy gathering part.

4. The ultrasonic energy gathering device of claim 1, wherein
an inner wall of the energy gathering part is a smooth plane, or the inner wall of the energy gathering part is provided with a smooth stepped surface.

5. An ultrasonic repeller, comprising an ultrasonic transmitting device and the ultrasonic energy gathering device of claim 1; wherein
the ultrasonic transmitting device comprises a transmitting device body, an ultrasonic transmitter and a transmitter shell;
the transmitting device body is provided at a rear end of the ultrasonic transmitter;
the ultrasonic transmitter is fixed in the transmitter shell;
the ultrasonic transmitter and the ultrasonic fixing part of the ultrasonic energy gathering device are fixed on the transmitter shell; and
a transmitting port of the ultrasonic transmitter is located at the gathering port of the ultrasonic energy gathering device.

6. The ultrasonic repeller of claim 5, further comprising a power source and a body shell; wherein
the power source is located at a tail part of the body shell, and the power source is electrically connected to the ultrasonic transmitting device; and
a head part of the body shell is fixed with the transmitter shell.

7. The ultrasonic repeller of claim 6, wherein
at least one button is provided on the transmitting device body, and the body shell is provided with an opening corresponding to the at least one button.

8. The ultrasonic repeller of claim 7, wherein
the body shell is further provided with a micro universal serial bus (USB) interface, and the micro USB interface is electrically connected to the power source.

9. The ultrasonic repeller of claim 5, wherein
an ultrasonic gain effect of the ultrasonic energy gathering device is in a positive correspondence relationship with a length of the energy gathering part; and
the ultrasonic gain effect increases as an energy gathering angle α approaches 30°, wherein the energy gathering angle α is an angle between an inner wall of the energy gathering part and an axial direction of the energy gathering part.

10. The ultrasonic repeller of claim 5, wherein
an energy gathering angle α is 20-35°, or the energy gathering angle α is 30°, wherein the energy gathering angle α is an angle between an inner wall of the energy gathering part and an axial direction of the energy gathering part.

11. The ultrasonic repeller of claim 5, wherein
an inner wall of the energy gathering part is a smooth plane, or the inner wall of the energy gathering part is provided with a smooth stepped surface.
